(19) United States
(12) Patent Application Publication
(10) Pub. No.: US 2008/0150277 A1
(43) Pub. Date: Jun. 26, 2008

(54) Method and assembly for repairing, joining or strengthening pipes made of plastics

(76) Inventors: Arturo Petruccelli, Busto Arsizio VA (IT); Marco Genoni, Arese MI (IT)

Correspondence Address: JACOBSON HOLMAN PLLC, 400 SEVENTH STREET N.W., SUITE 600, WASHINGTON, DC, 20004, US

(21) Appl. No.: 12/000,963

(22) Filed: Dec. 19, 2007

(30) Foreign Application Priority Data
Dec. 22, 2006 (IT) MI2006A 002503

(51) Int. Cl. F16L 47/00; F16L 55/18; F16L 13/00

(52) U.S. Cl. 285/15; 285/21.2; 285/285.1

(57) ABSTRACT

A method according to the invention, comprising the steps of producing a first band of material made of meltable plastics with incorporated heating conductors, winding the band on the pipe to cover the pipe zone to be repaired or joined, supplying the conductors electrically until desired melting of the material of the band melts is caused on the wound zone to create a cover block covering that zone. An assembly for implementing the method is also proposed.

### BACKGROUND OF THE INVENTION

1. Field of the Invention

The present invention relates to an innovative method and assembly for locally repairing or strengthening pipes made of plastics, in particular polyethylene.

2. State of the Prior Art

In the field of pipes made of plastics it may become necessary to repair or strengthen an already installed pipe in a zone that has, for example, been damaged during excavation work.

In the prior art, such repairs are normally conducted by cutting the piece of pipe with the damage and removing and replacing the piece of pipe with a new portion of pipe. In the case of weldable materials, the joints are often made by using two weldable sleeves. The cost of the operation both in terms of the time required and the need to empty the conduit in order to be able to section the conduit is clear.

The general object of the present invention is to overcome the aforesaid drawbacks by providing a method and a repair assembly that in a simple and fast manner enables the wall of the pipe in the damaged or insufficiently strong portion to be repaired without the need for removing or replacing. Advantageously, the method and the assembly may also be used to join pipe portions head to head.

“Repairing” will denote here also the strengthening of a pipe that has unsatisfactory local features.

### SUMMARY OF THE INVENTION

In view of the preset objects it was decided to create, according to the invention, a method for repairing, strengthening or joining pipes made of plastics that comprises the steps of producing a first band made of meltable plastics with incorporated heating conductors, winding the band around the pipe to cover the pipe zone that is to be repaired or joined, supplying the conductors electrically until a desired melting of the material of the band on the wound zone is caused to create a block covering that zone.

Still in view of the objects of the invention, it has been decided to create an assembly for repairing, strengthening or joining pipes made of plastics comprising a first band of material made of meltable plastics with incorporated heating conductors terminating in supply connectors on the band, the first band of material made of meltable plastics being intended to be wound around a pipe zone to be joined or repaired and to be supplied electrically until a desired melting of the material of the band on the wound zone is achieved to create a block made of plastics covering this zone.

The invention also relates to a pipe with a strengthened portion, comprising a pipe made of plastics that is covered in the strengthened portion with a first band made of meltable material containing heating conductors wound spirally thereupon and melted to form a strengthening block made of plastics.

For example, from U.S. Pat. No. 4,436,988 meltable bands are known to be wound on pipes but such bands are proposed and used only as an intermediate welding element, for example between the end of a pipe and sleeve or a junction fitted thereon. No possibility of repairing, joining directly or strengthening pipes is proposed in the prior art.

### BRIEF DESCRIPTION OF THE DRAWINGS

In order to make clearer the explanation of the innovative principles of the present invention and the advantages thereof over the prior art, with the help of the attached drawings a possible embodiment applying such principles will be disclosed below by way of example. In the drawings:

FIG. 1 is a schematic view of an assembly according to the invention in an intermediate installation step;

FIG. 2 is a schematic view of a possible cover element of the assembly in FIG. 1;

FIG. 3 is a partial schematic view of an element of the assembly in FIG. 1;

FIG. 4 is a cross-section view of a possible embodiment of the element in FIG. 3;

FIG. 5 is a schematic view of the assembly in FIG. 1 after installation has been completed.

### DETAILED DESCRIPTION OF THE INVENTION

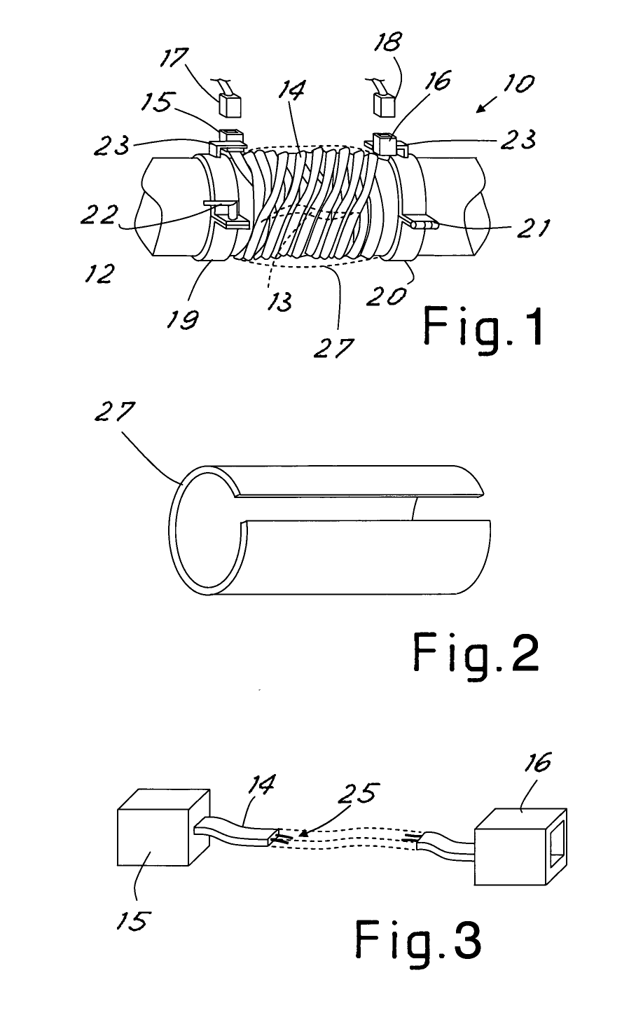

With reference to the figures, in FIG. 1 there is shown an assembly according to the invention, indicated generically by 10, in an intermediate installation step. In the example, the assembly is used for repairing a pipe 12 made of weldable plastics (for example made of polyethylene or covered in polyethylene) that has a defect 13 to be repaired. The defect may be a weakening of the wall of the pipe, due, for example, to accidental mechanical removal of material. For example, during excavation work similar defects are often produced on buried pipes.

The assembly 10 comprises a band 14 made of weldable material that is compatible with the pipe (for example, polyethylene) incorporating electric heating conductors. The conductors terminate at connectors 15, 16 for connecting to suitable connectors 17, 18 of an electric supply apparatus (which is prior art and is therefore not shown).

Advantageously, the assembly comprises a pair of clamps 19, 20 to be mounted temporarily as collars on the pipe at the two ends of the zone to be repaired. The clamps are advantageously two annular elements, which are the same as one another and formed into two halves with removable clamping means. The two halves can be advantageously hinged in 21 and with a clamping means (for example screw clamping means) in 22. Each clamp has coupling means, such as a coupling protrusion 23 to hold one of the two ends of the band in position.

In this manner, once the two clamps have been fitted to the pipe, it is possible to hold a first connector of the band 14 on one of the clamps and easily wind the band on the portion of pipe until the other clamp is reached to which to fix the other connector.

Fixing can occur simply through traction in the winding direction and snapping into the connector between the (L-shaped) protrusion 23 and the wall of the pipe, as is easily discernable from FIG. 1.

Advantageously, bands can be provided that are of a length that is appropriate to the diameter of the pipe and the portion to be repaired so that the space between the clamps is filled correctly with partially superimposed coils of the band.

Still advantageously, the band 14 is wound on the pipe in at least two superimposed layers.

Once the band has been installed, it can be supplied electrically to produce the melting thereof so as to make a single layer covering the portion of pipe with the coils that have been welded together and to the external wall of the pipe. A monobloc is thus made that repairs the pipe perfectly. After cooling, the clamps can be removed and reused for another repair. In FIG. 5 the result of the repair is shown.

It should be noted that the electric wires in the band, once melting has terminated, form a reinforcement of the repair, being incorporated into a monobloc piece of melted plastics.

Advantageously, there can be provided a containing element 27 (represented by a broken line in FIG. 1) for containing the meltable material during the heating and melting step. In a first advantageous embodiment this containing element is made of a second band made of meltable material wound around the first band 14. This second band may be completely similar to the first but not be supplied electrically for melting, or be a covering band, devoid of internal heating conductors.

In the case of the use of a covering band, it has been found to be advantageous for the two bands to be superimposed with crossed coils, in particular at an angle between 40 and 60 degrees, preferably around 50 degrees, for greater repair strength.

In a second possible embodiment, as shown in FIG. 2, the containing element 27 can be made with a tubular element split longitudinally to be able to be opened through elastic deformation and arranged for grasping the band 14 wound around the pipe. The material of this element can still be made of meltable plastics that are compatible with the band 14 or also be made of metal material. It can also be made of a sheet (for example of aluminum) to be wound on the zone between the clamps.

In FIG. 3 there is shown in greater detail a possible embodiment of the band 14 with the end clamps 15 and 16. A part of the band is plotted in the figure to show the internal conductors 25. The band will have a width and thickness that are suitable for the specific need. The connectors can also be of a known perforated insulating type so as to be seamable on the band, cut to measure from a strip.

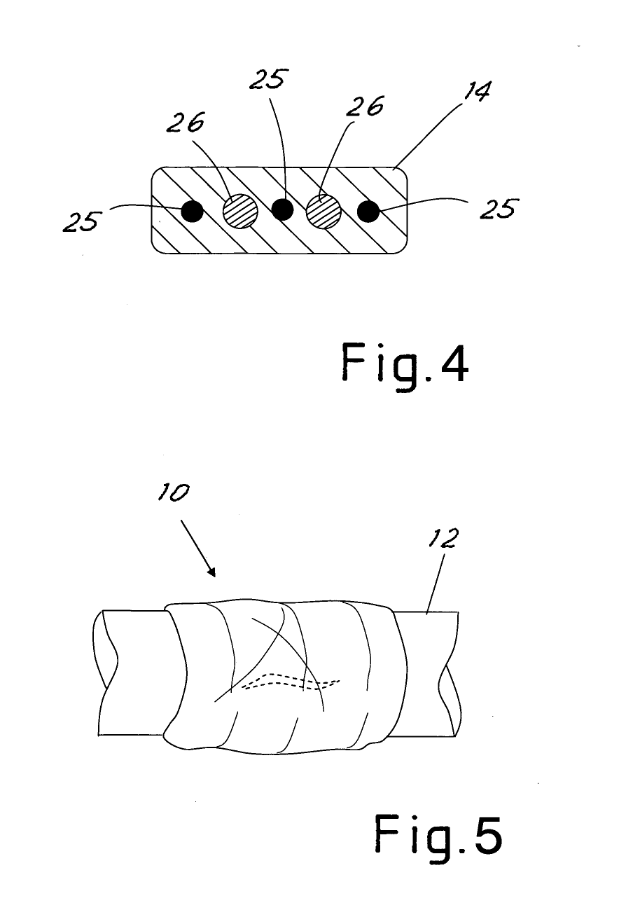

In FIG. 4 there is shown a possible embodiment of the band, where heating and melting conductors 25 and further strengthening metal wire-shaped elements 26 are used, which are advantageously parallel and interspersed with the conductors. This can be useful when further strengthening is necessary compared with the strengthening provided by only the conductors 25. The conductors can also be made of material that is not excessively strong and the entire strengthening function can be provided by additional wires 26, for example made of steel or steel braid. The strengthening block that covers the strengthened pipe has been found to provide the pipe with great mechanical features.

The strengthening provided according to the principles of the invention can also be adopted when the defect of the pipe consists of an unacceptable weakness of the wall, not only through mechanical nicking, but also, for example, through stress, physical-chemical degradation or changes in local conditions of use.

It is now clear how the preset objects have been achieved by providing a method and an assembly for repairing pipes that enable pipes to be repaired rapidly and robustly. With a suitable number of band 14 coils according to the method a head-head joint can be made between two pipes, for example to repair a complete or partially complete breakage of the pipe and to provide a joint between new portions of pipe.

Naturally, the above description of an embodiment applying the innovative principles of the present invention is provided by way of example of such innovative principles and must not therefore be taken to limit the scope of what is claimed herein. For example, different systems for temporarily holding of the ends of the band can be used. The number of conductors in the band may be different from two also on the basis of the actual cross section of the band. The band can also provide electric terminals at only one end, by serial joining of at least two conductors at the other end. The strengthening assembly formed by the band, by the clamps and by any possible containing element can also be provided in kits that are suitable for the various diameters and types of pipe so as to facilitate the choice by the user according to specific repair needs.

What is claimed is:

1. Method for repairing, strengthening or joining pipes made of plastics comprising the steps of producing a first band of material made of meltable plastics with incorporated heating conductors, winding the band on the pipe to cover the zone of pipe to be repaired or joined, supplying electrically the conductors until a desired melting of the material of the band on the wound zone is caused to make a covering block covering this zone.

2. Method according to claim 1, comprising the further intermediate step of covering with a containing layer the first band wound on the pipe before the melting step.

3. Method according to claim 2, wherein the containing layer is a second band wound above the first band.

4. Method according to claim 3, wherein the second band is also made of meltable plastics.

5. Method according to claim 3, wherein the first and second band are wound in crossed coils.

6. Method according to claim 5, wherein the coils of the first and second band are crossed at an angle comprised between 40 and 60 degrees, preferably around 50 degrees.

7. Method according to claim 2, wherein the containing layer is a sheet wound above the first band.

8. Method according to claim 2, wherein the containing layer is a tubular element split longitudinally to be openable laterally and fitted on the pipe to grasp the zone wound by the first band.

9. Method according to claim 1, wherein the first band is wound in at least two superimposed layers.

10. Method according to claim 1, comprising the further step of positioning clamps at the ends of the zone to be wound in order to anchor thereupon the ends of the first band before the melting step.

11. Assembly for repairing, strengthening or joining pipes made of plastics comprising a first band of material made of meltable plastics with incorporated heating conductors terminating in supply connectors on the band and intended to be wound on a pipe zone to be joined or repaired and to be supplied electrically until desired melting of the material of the band on the wound zone is caused to make a block made of plastics covering the zone.

12. Assembly according to claim 10, characterized in that it comprises two clamps intended to be arranged at the two ends of the zone of the pipe to be wound and provided with means for anchoring thereto the ends of the first band before the melting thereof.

13. Assembly according to claim 10, characterized in that it comprises an electric connector at each end of the first band.

14. Assembly according to claim 12, characterized in that the two clamps are annular and consist of two mutually openable halves for mounting on the pipe and with removable clamping means.

15. Assembly according to claim 11, characterized in that the first band has wire-shaped strengthening elements internally.

16. Assembly according to claim 15, characterized in that the wire-shaped strengthening elements are interspersed with the conductors.

17. Assembly according to claim 11, characterized in that it comprises a containing element containing the first band wound on the pipe.

18. Assembly according to claim 16, characterized in that the containing element is a second band to be wound above the first band.

19. Assembly according to claim 17, characterized in that the second band is also made of meltable plastics.

20. Assembly according to claim 17, characterized in that the containing element is a sheet to be wound above the first band.

21. Assembly according to claim 19, characterized in that the sheet is metal.

22. Assembly according to claim 17 characterized in that the containing element is a tubular element split longitudinally to be openable laterally and insertable on the pipe to grasp the zone wound by the first band.

23. Pipe with a strengthened portion, comprising a pipe made of plastics covered in that portion with a first band made of meltable material containing heating conductors, wound spirally thereupon and melted to form a strengthening block made of plastics.

24. Pipe according to claim 22, characterized in that the strengthening block includes wire-shaped strengthening elements arranged spirally around the pipe.

25. Pipe according to claim 24, characterized in that the wire-shaped strengthening elements are interspersed with the conductors.
